(19) United States
(12) Patent Application Publication
(10) Pub. No.: US 2006/0231587 A1
(43) Pub. Date: Oct. 19, 2006

(54) Apparatus for performing a plurality of magnetic pulse forming or welding operations

(76) Inventors: Mark W. Kiehl, Bernville, PA (US); John L. Kichline JR., Reading, PA (US); Richard L. Stuck, Stevens, PA (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/314,974

(22) Filed: Dec. 21, 2005

Related U.S. Application Data
(63) Continuation of application No. PCT/US04/20622, filed on Jun. 28, 2004.
(60) Provisional application No. 60/484,070, filed on Jul. 1, 2003.

(51) Int. Cl. A47J 36/02

(52) U.S. Cl. 228/101

(57) ABSTRACT

An apparatus for performing a plurality of magnetic pulse forming or welding operations includes a power supply, a plurality of inductors, and a power distribution system for selectively connecting the power supply to each of the plurality of inductors so as to perform a plurality of magnetic pulse forming or welding operations. The power distribution system can include a power distribution device having either (1) a connection arm that can be connected to each of the plurality of inductors, (2) a plurality of connection cables that can be connected to each of the plurality of inductors, or (3) a solid state switching system for electronically connecting the power supply to each of the plurality of inductors. Alternatively, the power distribution system can include a power distribution bus including first and second electrical conductors that are separated by an electrical insulator and a plurality of switches respectively associated with the plurality of inductors for selectively connecting each of the inductors to the power distribution bus.

### CROSS-REFERENCE TO RELATED APPLICATIONS

This application is a continuation of International Application No. PCT/US04/020622, filed Jun. 28, 2004, which claims priority from U.S. Provisional Application No. 60/484,070, filed Jul. 1, 2003. The disclosures of both applications are incorporated herein by reference.

### BACKGROUND OF THE INVENTION

This invention relates in general to magnetic pulse forming techniques for deforming a metallic component and to magnetic pulse welding techniques for permanently joining metallic components. In particular, this invention relates to an improved method and apparatus for performing a plurality of magnetic pulse forming or welding operations in which a plurality of electromagnetic inductors are sequentially energized at a variety of physical locations.

Magnetic pulse forming and magnetic pulse welding are well known processes that can be used to either deform or permanently join metallic components, such as vehicle frame components. Typically, a magnetic pulse forming or welding operation is performed by initially disposing portions of first and second components in an overlapping relationship. An electromagnetic inductor or coil is provided for generating a magnetic field either within or about the overlapping portions of the first and second components. When this occurs, a large pressure is exerted on one of the first and second components, causing it to move toward the other of the first and second components. If the electromagnetic inductor is disposed about the exterior of the two components, then the outer component is deformed inwardly into engagement with the inner component. If, on the other hand, the electromagnetic inductor is disposed within the interior of the two components, then the inner component is deformed outwardly into engagement with the outer component.

To perform a magnetic pulse forming process, the component that is desired to be re-shaped is formed from a metallic material (the other component can be formed from any desired material, inasmuch as it usually functions as a mandrel or a die against which the metallic component is deformed). In a magnetic pulse forming process, the inductor is energized so as to generate a magnetic field having a sufficient intensity to deform the metallic component into engagement with the other component, thereby re-shaping it to a desired configuration. To perform a magnetic pulse welding process, however, both of the components are formed from metallic materials (although the two components need not be formed from the same metallic material). In a magnetic pulse welding process, the inductor is energized so as to generate a magnetic field having a sufficient intensity to not only deform the metallic component into engagement with the other component, but also to impact the other component at a relatively high velocity. When this occurs (and other conditions have been met), the first and second metallic components can become permanently joined or welded together.

The magnetic pulse forming and welding processes operate on the principle that when opposing magnetic fields are created about respective electrical conductors that are located adjacent to one another, a repulsive force is generated therebetween. More specifically, a primary magnetic field is generated about the inductor by the passage of electrical current therethrough. This primary magnetic field causes eddy currents to be induced in the first metallic component. These eddy currents, in turn, cause a secondary magnetic field to be generated about the first metallic component that is opposed to the primary magnetic field generated by the inductor. Thus, a repulsive force is generated by the inductor against the first metallic component, causing it to move away from the inductor and into engagement with the second component. As a result, the first component is deformed into engagement with the second component and, as described above, may become permanently joined or welded thereto.

Although these processes have functioned effectively, they have been found to be somewhat difficult to employ in some instances, particularly when a plurality of metallic components are deformed or joined together at a plurality of different locations. These instances can, for example, occur when the various components being joined together are vehicle frame components and require that a plurality of magnetic pulse forming or welding operations be performed. For the sake of maximum efficiency, it is desirable to perform each of these magnetic pulse forming or welding operations as quickly as possible. However, known structures for performing magnetic pulse forming and welding operations are not readily suited for performing a plurality of such operations in a variety of physical locations in a relatively fast manner. Thus, it would be desirable to provide an improved method and apparatus that facilitates the performance of a plurality of magnetic pulse forming and welding operations in a variety of physical locations.

### SUMMARY OF THE INVENTION

This invention relates to an improved method and apparatus for performing a magnetic pulse forming or welding operation in which a plurality of electromagnetic inductors are sequentially energized to deform or permanently join the two metallic components. The apparatus includes a power supply, a plurality of inductors, and a power distribution system for selectively connecting the power supply to each of the plurality of inductors so as to perform a plurality of magnetic pulse forming or welding operations. The power distribution system can include a power distribution device having either (1) a connection arm that can be connected to each of the plurality of inductors, (2) a plurality of connection cables that can be connected to each of the plurality of inductors, or (3) a solid state switching system for electronically connecting the power supply to each of the plurality of inductors. Alternatively, the power distribution system can include a power distribution bus including first and second electrical conductors that are separated by an electrical insulator and a plurality of switches respectively associated with the plurality of inductors for selectively connecting each of the inductors to the power distribution bus. The first and second electrical conductors can include first and second flat, planar conductor plates, and the electrical insulator can include a flat, planar insulator plate disposed between the first and second conductor plates.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a block diagram of an apparatus for performing a plurality of magnetic pulse forming or welding operations in accordance with this invention.

FIG. 2 is a schematic top plan view of a first embodiment of a power distribution system of the apparatus illustrated in FIG. 1, wherein the first embodiment of the power distribution system is shown in a first stage of operation for joining a plurality of vehicle frame components together to form a vehicle frame assembly.

FIG. 3 is a schematic top plan view of the first embodiment of the power distribution system illustrated in FIG. 2 shown in a second stage of operation.

FIG. 4 is a sectional elevational view of a joint between two of the vehicle frame components illustrated in FIGS. 2 and 3 prior to being joined together.

FIG. 5 is a sectional elevational view of the joint illustrated in FIG. 4 showing the vehicle frame components after being joined together.

FIG. 6 is a schematic top plan view of the first embodiment of the power distribution system illustrated in FIG. 2 shown in a third stage of operation.

FIG. 7 is a schematic top plan view of a second embodiment of a power distribution system of the apparatus illustrated in FIG. 1 in accordance with this invention.

FIG. 8 is a schematic top plan view of a third embodiment of a power distribution system of the apparatus illustrated in FIG. 1 in accordance with this invention.

FIG. 9 is a block diagram of a modified apparatus for performing a plurality of magnetic pulse forming or welding operations in accordance with this invention.

FIG. 10 is a schematic front perspective view of the modified apparatus illustrated in FIG. 9 shown in a first stage of operation.

FIG. 11 is a schematic front perspective view of the modified apparatus illustrated in FIGS. 9 and 10 (the switches have been omitted for the sake of clarity) shown in a second stage of operation.

FIG. 12 is an enlarged side elevational view of one of the switches of the modified apparatus illustrated in FIGS. 10 and 11 shown in an opened condition.

FIG. 13 is a further enlarged side elevational view of a portion of the switch illustrated in FIG. 12 shown in an opened condition.

FIG. 14 is an enlarged side elevational view similar to FIG. 13 showing the switch in a closed condition.

### DETAILED DESCRIPTION OF THE PREFERRED EMBODIMENTS

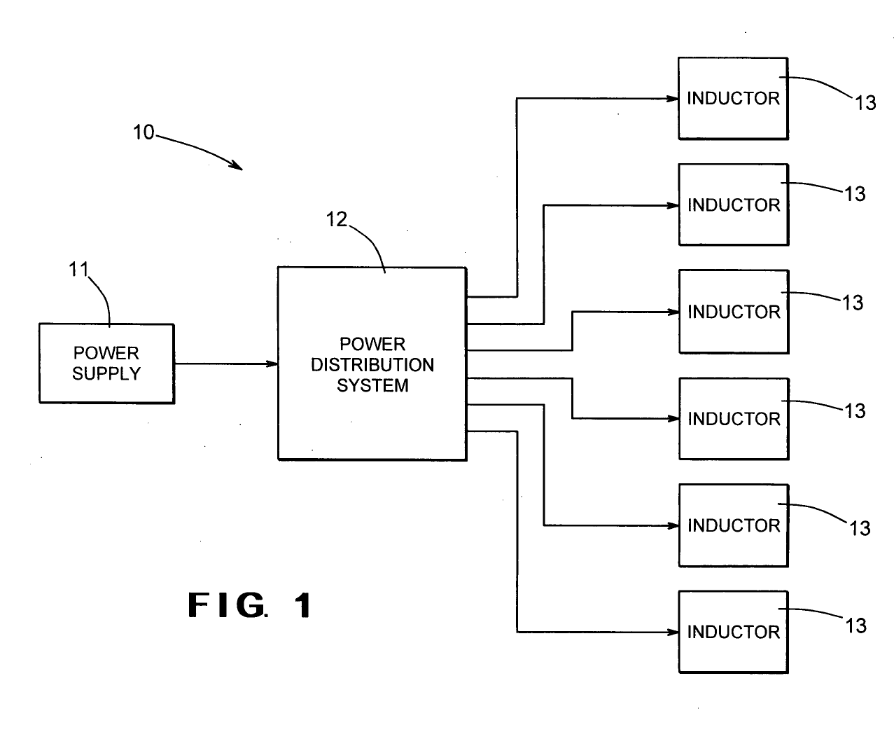

Referring now to the drawings, there is illustrated in FIG. 1 a block diagram of an apparatus, indicated generally at 10, for performing a plurality of magnetic pulse forming or welding operations in a quick and efficient manner in accordance with this invention. The magnetic pulse forming/welding apparatus 10 includes a power supply 11, a power distribution system 12, and a plurality of inductors 13. The power supply 11 is conventional in the art and is adapted to supply electrical energy through the power distribution system 12 to each of the inductors 13. In a manner that is described in detail below, the power distribution system 12 selectively and sequentially connects the power supply 11 to each of the inductors 13 so as to perform a plurality of magnetic pulse forming or welding operations, as described above. The power distribution system 12 can be embodied in a variety of structures that are also described in detail below.

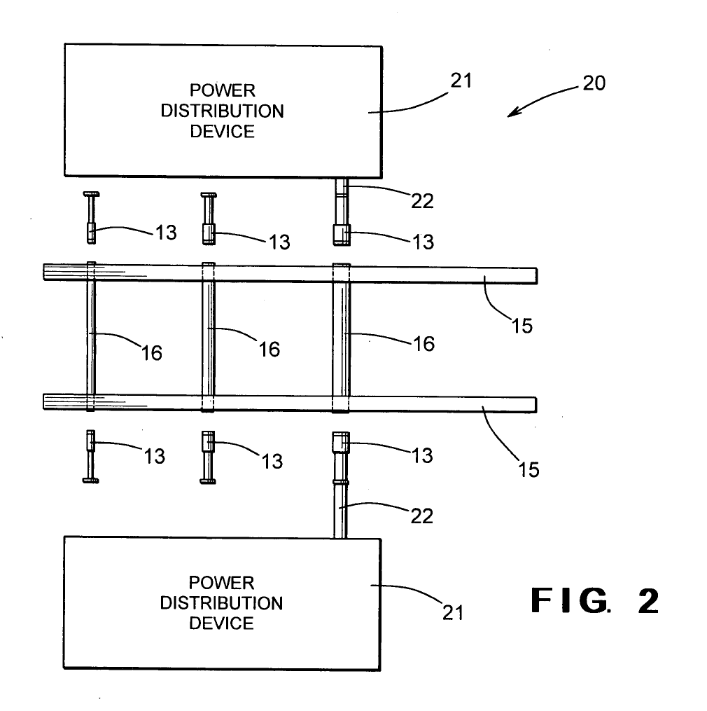

FIG. 2 is a schematic top plan view of a first embodiment, indicated generally at 20, of the power distribution system 12 of the apparatus 10 illustrated in FIG. 1. For the sake of illustration, the operation of the apparatus 10 will be described in the context of performing a plurality of magnetic pulse welding operations to secure a plurality of vehicle frame components, such as a pair of side rails 15 and a plurality of cross members 16, together to form a vehicle frame assembly. However, it will be appreciated that the method and apparatus of this invention can be used to perform a magnetic pulse forming operation, and further can be used to manufacture any desired type of structure.

Prior to being joined together, the various components 15 and 16 are typically supported on a conventional fixture (not shown) for locating such components 15 and 16 in a precise orientation relative to one another, such as shown in FIG. 2. In this orientation, the end portions of the cross members 16 are inserted within portions of the side rails 15 to form respective joints. The structure of one of these joints will be described in detail below. Additionally, some or all of the inductors 13 may be supported on the fixture in position relative to the components 15 and 16 to be joined together. Alternatively, the inductors 13 may be supported on one or more mounting structures (not shown) that are separate and apart from the fixture. Regardless, in the manner described in detail below, the apparatus 10 is thereafter operated to permanently secure all of the components 15 and 16 together in the desired configuration.

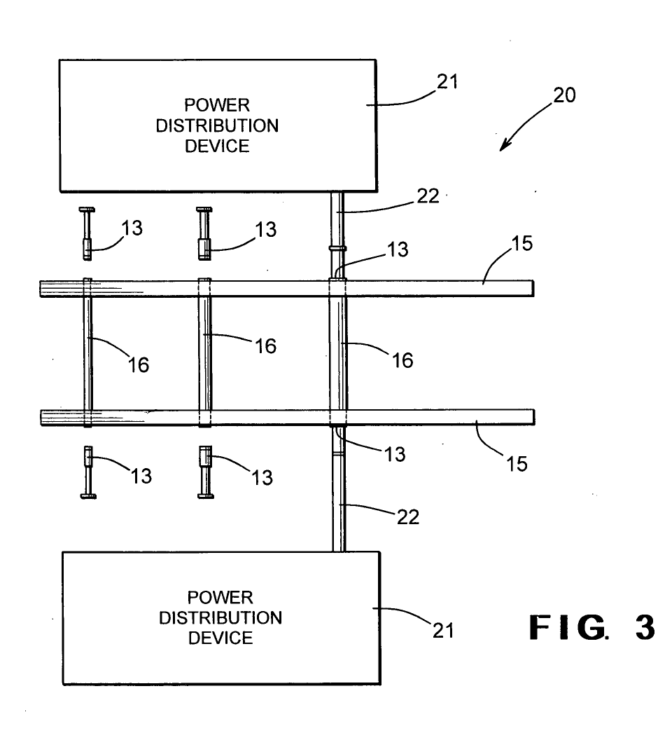

In the first embodiment 20 of the power distribution system 12, one or more power distribution devices 21 are provided between the power supply 11 and each of the inductors 13. In the illustrated embodiment, two of such power distribution devices 21 are provided. However, a greater or lesser number of such power distribution devices 21 may be provided as desired. Each of the power distribution devices 21 is electrically connected to the power source 11 and is movable in any desired direction relative the components 15 and 16 that are supported on the fixture and to the inductors 13. Each of the power distribution devices 21 includes a connection arm 22 that can be aligned with and electrically connected to each of the inductors 13 for supplying electrical energy from the power supply 11 thereto. To accomplish this, the power distribution devices 21 are initially moved to the positions illustrated in FIG. 2, wherein the two connection arms 22 are aligned with a first pair of the inductors 13 that, in turn, are aligned with a first one of the cross members 16. Alternatively, the fixture can be moved relative to the power distribution devices 21 to achieve this alignment. In either event, the connection arms 22 are then extended such that they engage and are electrically connected to the first pair of the inductors 13. The connection arms 22 can be embodied as any desired mechanical and electrical structures for accomplishing this. Then, as shown in FIG. 3, the connection arms 22 are further extended such that each of the first pair of the inductors 13 is inserted within the components 15 and 16 that are to be joined together. If desired, the inductors 13 can be initially supported within the components 15 and 16, and the connection arms 22 can be extended to be electrically connected thereto. In either instance, each of the inductors 13 is disposed within the components 15 and 16 that are to be joined together.

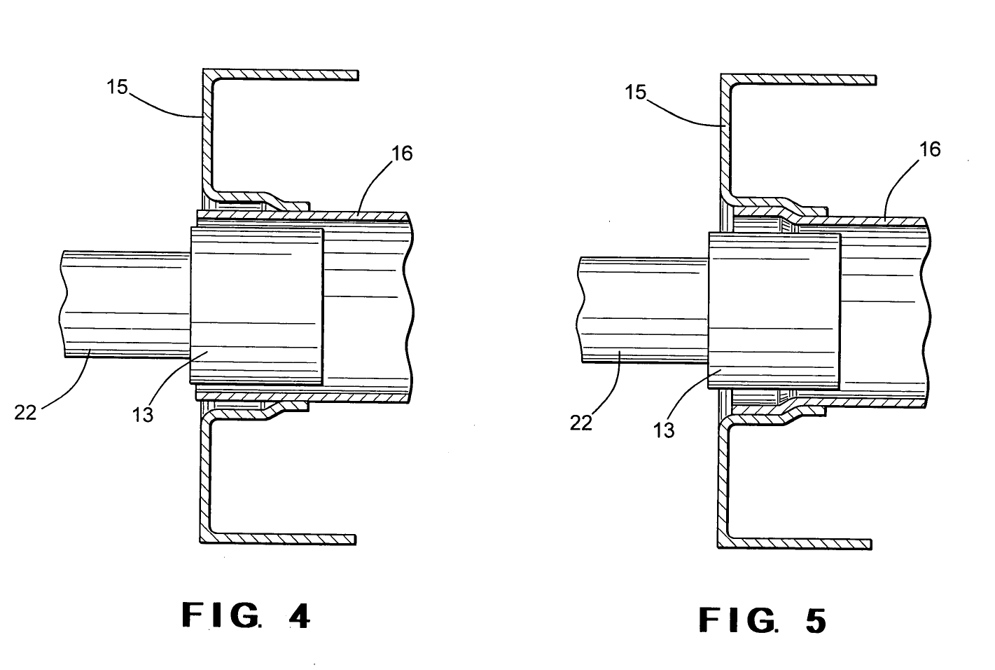

Referring to FIG. 4, there is illustrated a representative embodiment of a joint between the side rail 15 and one of the ends of the cross member 16. The side rail 15 includes a central web having upper and lower flanges extending therefrom. A portion of the web is deformed inwardly to provide an opening defining a cross member mounting projection. The mounting projection is preferably sized to receive the end of the cross member 16 therein to form the joint between the side rail 15 and the cross member 16. In the illustrated embodiment, the mounting projection is generally cylindrical in shape, corresponding to the generally cylindrical shape of the end of the cross member. However, it will be appreciated that the mounting projection and the end of the cross member may have any desired shapes. The mounting projection may be formed having a first relatively large diameter portion and a second relatively small diameter portion. The relatively large diameter portion of the mounting projection is somewhat larger in diameter than the outer diameter of the end of the cross member, thus providing a relatively large annular gap therebetween, as shown in FIG. 4. The relatively small diameter portion of the mounting projection is only slightly larger in diameter than the outer diameter of the end of the cross member 16, thus providing a relatively small annular gap therebetween.

The inductor 13 is conventional in the art and includes an electromagnetic coil (not shown) that is carried at the end of the connection arm 22. The coil is composed of a winding of an electrical conductor having a pair of leads that extend therefrom to the power supply 11. When the power supply 11 is activated, electrical current flows through the coil of the inductor 13, causing an intense electromagnetic field to be generated thereabout. The presence of this electromagnetic field causes the end of the cross member 16 to expand outwardly at a high velocity into engagement with the mounting projection of the side rail 15. Such high velocity engagement causes some portions of the side rail 15 and the end of the cross member 16 to weld or molecularly bond together, as shown in FIG. 5, to form a permanent joint therebetween.

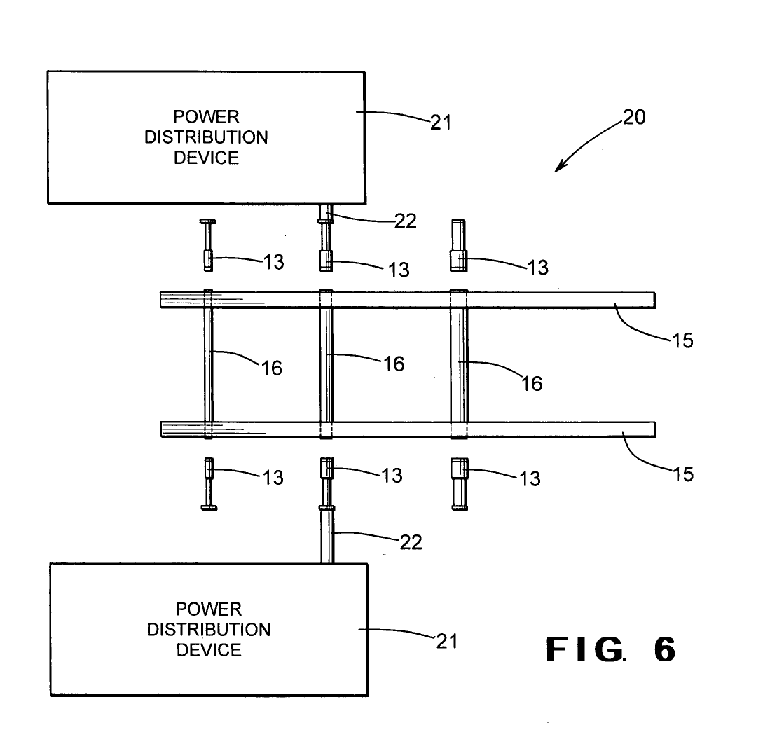

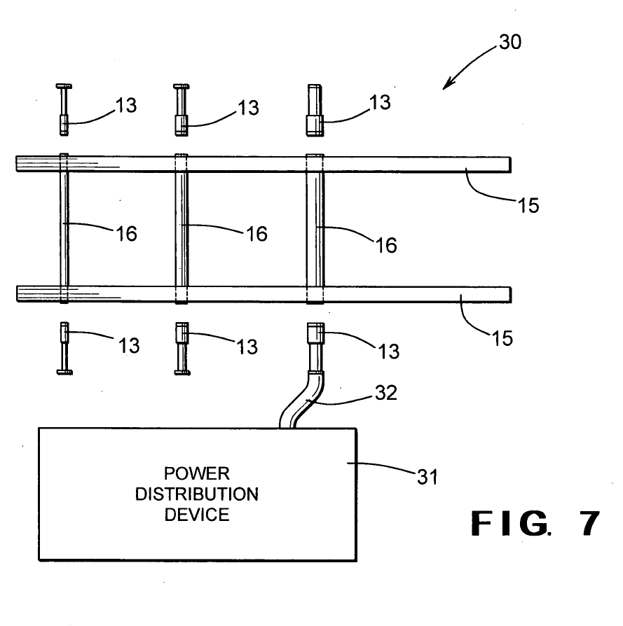

After the permanent joints have been made between the side rail 15 and the ends of the first cross member 16, the power supply 11 is de-activated, causing electrical current to cease to flow through the coil of the inductor 13. Then, the connection arms 22 can be retracted to the positions illustrated in FIG. 2 and electrically disconnected from the first pair of the inductors 13. Next, the power distribution devices 21 relative the components 15 and 16 that are supported on the fixture and to the inductors 13 to the positions illustrated in FIG. 6, wherein the two connection arms 22 are aligned with a second pair of the inductors 13 that, in turn, are aligned with a second one of the cross members 16. The same sequence of operations as described above can be performed to form permanent joints between the side rail 15 and the ends of the second one of the cross members 16.

FIG. 7 is a schematic top plan view of a second embodiment, indicated generally at 30, of the power distribution system 12 of the apparatus 10 illustrated in FIG. 1. In the second embodiment 30 of the power distribution system 12, one or more power distribution devices 31 are provided between the power supply 11 and each of the inductors 13. In the illustrated embodiment, only one of such power distribution devices 31 is provided. However, a greater number of such power distribution devices 31 may be provided as desired. The power distribution device 31 is electrically connected to the power source 11 and is fixed in position relative the components 15 and 16 that are supported on the fixture and to the inductors 13. The power distribution device 31 includes a connection cable 32 that can be electrically connected to each of the inductors 13 for supplying electrical energy from the power supply 11 thereto. To accomplish this, the connection cable 32 is electrically connected to one of the inductors 13, as shown in FIG. 7. The connection cable 32 can be embodied as any desired mechanical and electrical structure for accomplishing this. Then, in the same manner as described above, the connection cable 32 is further extended such that the inductor 13 is inserted within the components 15 and 16 that are to be joined together. If desired, the inductor 13 can be initially supported within the components 15 and 16, and the connection cable 32 can be electrically connected thereto. In either instance, the inductor 13 is disposed within the components 15 and 16 that are to be joined together. The same sequence of operations as described above can be performed to form permanent joints between the side rail 15 and the ends of the second one of the cross members 16.

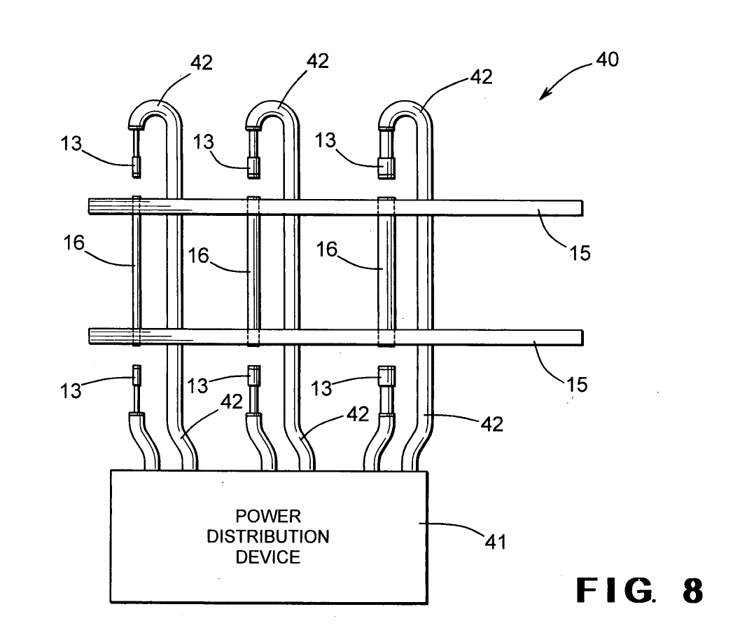

FIG. 8 is a schematic top plan view of a third embodiment, indicated generally at 40, of the power distribution system 12 of the apparatus 10 illustrated in FIG. 1. In the third embodiment 40 of the power distribution system 12, one or more power distribution devices 41 are provided between the power supply 11 and each of the inductors 13. In the illustrated embodiment, only one of such power distribution devices 41 is provided. However, a greater number of such power distribution devices 41 may be provided as desired. The power distribution device 41 is electrically connected to the power source 11 and is fixed in position relative the components 15 and 16 that are supported on the fixture and to the inductors 13. The power distribution device 41 includes a plurality of connection cables 42 that can be electrically connected to each of the inductors 13 for supplying electrical energy from the power supply 11 thereto. To accomplish this, each of the connection cables 42 is electrically connected to one of the inductors 13, as shown in FIG. 8. The connection cables 32 can be embodied as any desired mechanical and electrical structures for accomplishing this. Then, in the same manner as described above, the connection cables 42 are further extended such that the inductor 13 are inserted within the components 15 and 16 that are to be joined together. If desired, the inductors 13 can be initially supported within the components 15 and 16, and the connection cables 32 can be electrically connected thereto. In either instance, the inductors 13 are disposed within the components 15 and 16 that are to be joined together. The same sequence of operations as described above can be performed to form permanent joints between the side rail 15 and the ends of the second one of the cross members 16. If desired, all of the inductors 13 can be energized simultaneously to simultaneously form all of the joints between the two side rails 15 and the ends of all of the cross members 16. Preferably, however, the inductors 13 are energized sequentially to sequentially form the joints between the two side rails 15 and the ends of all of the cross members 16. Such sequential operation can be accomplished through appropriate switch mechanisms (not shown) either within the power distribution device 41 or within the power supply 11.

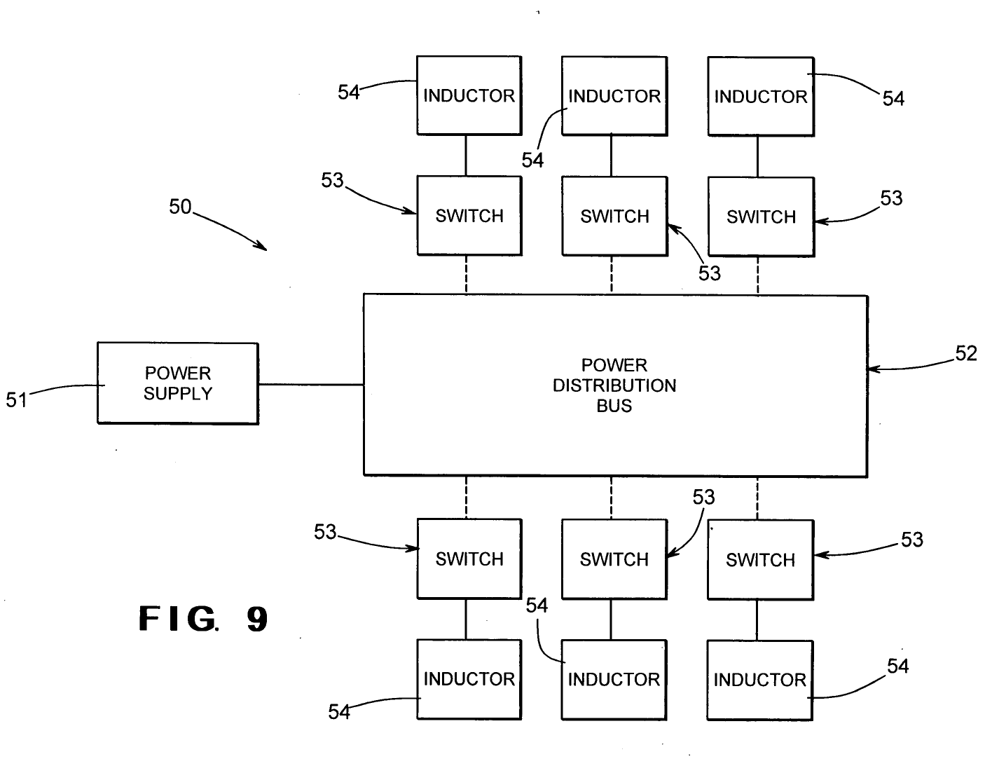

Referring now to FIG. 9, there is illustrated a block diagram of a modified apparatus, indicated generally at 50, for performing a plurality of magnetic pulse operations in a quick and efficient manner in accordance with this invention. The modified magnetic pulse welding apparatus 50 includes a power supply 51, a power distribution bus indicated generally at 52, a plurality of switches indicated generally at 53, and a plurality of inductors 54. The power supply 51 is conventional in the art and is adapted to supply electrical energy through the power distribution bus 52 and each of the switches 53 to each of the inductors 54. In a manner that is described in detail below, the power distribution bus 52 and the switches 53 selectively and sequentially connect the power supply 51 to each of the inductors 54 so as to perform a plurality of magnetic pulse welding operations.

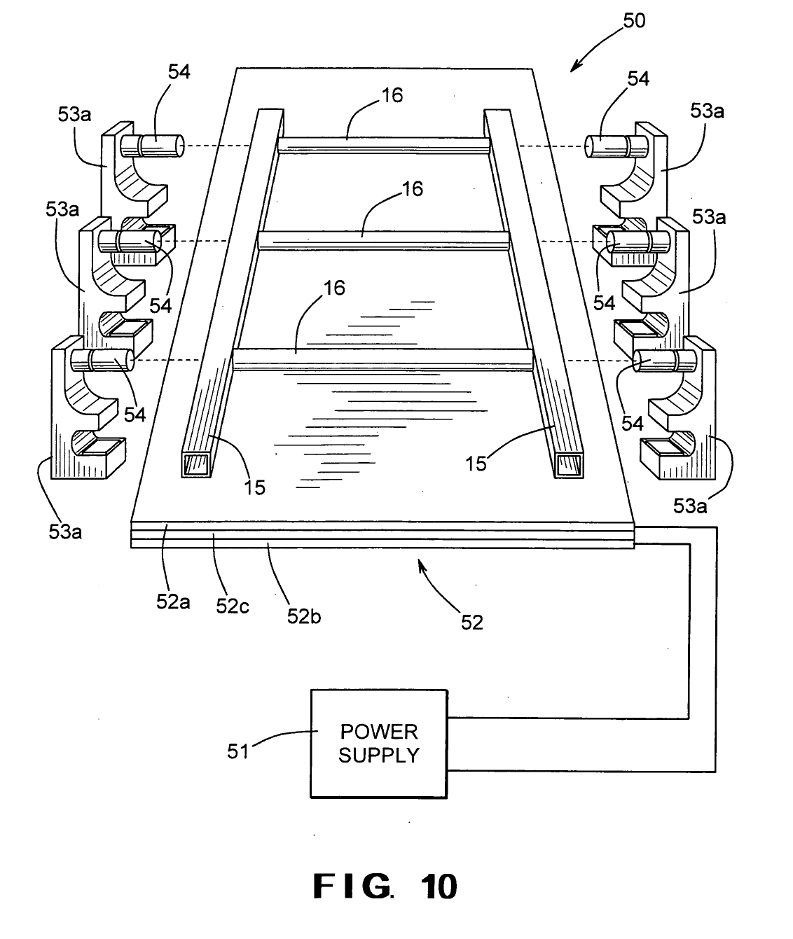

FIG. 10 is a schematic front perspective view of the modified apparatus 50 illustrated in FIG. 9 shown in a first stage of operation. As described above, prior to being joined together, the various components 15 and 16 can be supported on a conventional fixture (not shown) for locating such components in a precise orientation relative to one another. Additionally, some or all of the inductors 54 may be supported on the fixture in position relative to the components to be joined together. Alternatively, the inductors 54 may be supported on one or more mounting structures (not shown) that are separate and apart from the fixture. Regardless, in the manner described in detail below, the modified apparatus 50 is thereafter operated to permanently secure all of the components 15 and 16 together in the desired configuration.

The power distribution bus 52 of the modified apparatus 50 includes first and second electrical conductors that are separated by an electrical insulator. As shown in FIG. 10, the illustrated first and second electrical conductors are embodied as flat, planar conductor plates 52a and 52b that are each formed from an electrically conductive material, while the illustrated electrical insulator is embodied as a flat, planar insulator plate 52c of an electrically insulative material that is disposed between the conductor plates 52a and 52b. It will be appreciated, however, that the first and second electrical conductors and the electrical insulator can be embodied having any desired geometry, such as a co-axial cable, for example. The power supply 51 includes first and second terminals that are respectively connected to the conductor plates 52a and 52b of the power distribution bus 52. Thus, when the power supply 51 is activated, the conductor plates 52a and 52b of the power distribution bus 52 are electrically charged. However, because such conductor plates 52a and 52b are separated from one another by the insulator plate 52c, an open circuit is formed, and no electrical current flows therethrough.

In the illustrated embodiment, each of the switches 53 supports an associated one of the inductors 54 thereon, although such is not required. The switches 53 and the inductors 54 are preferably supported for movement in any desired direction relative the components 15 and 16 that are supported on the fixture and to the power distribution bus 52. To accomplish this, each of the switches 53 can be supported on or otherwise engaged by one or more actuators (not shown) for such relative movement. For example, hydraulic or pneumatic actuators can be employed to accomplish such movement.

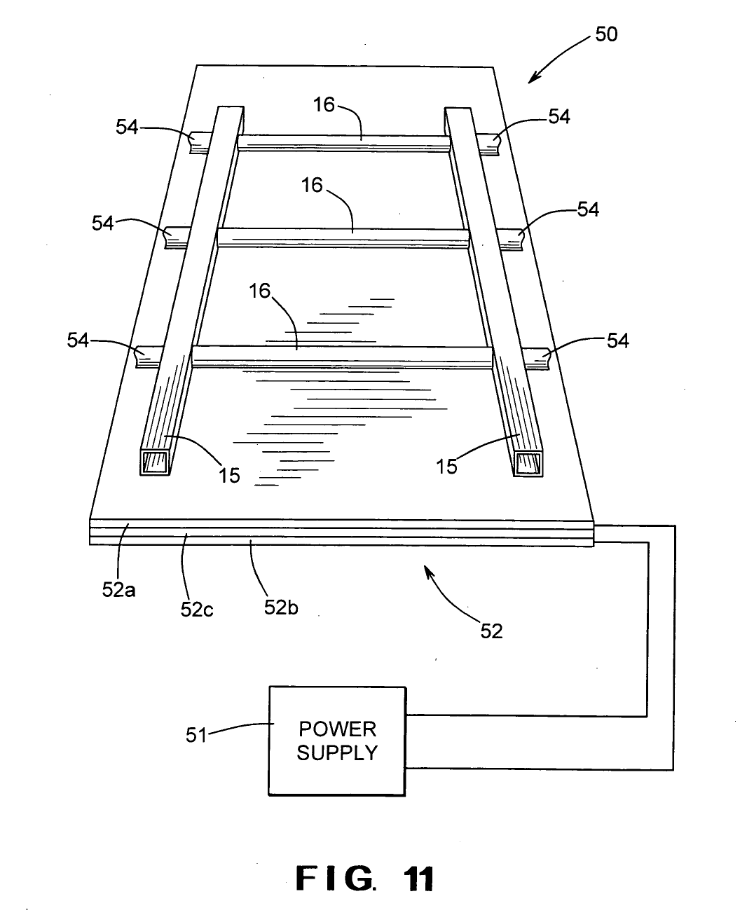

The operation of the modified apparatus 50 will now be described. Initially, as described above, the various components 15 and 16 are supported on the fixture for locating such components 15 and 16 in a precise orientation relative to one another, and each of the inductors 54 is aligned within the components 15 and 16 that are to be joined together, as shown in FIG. 10. This can be accomplished by initially operating the various actuators such that the inductors 54 are pre-positioned before the components 15 and 16 are supported on the fixture. Alternatively, the components 15 and 16 can be initially supported on the fixture, and the various actuators can then be operated to position the inductors 54 relative thereto. In either event, the actuators are then operated to move the switches 53 and the inductors 54 such that each of the inductors 54 is disposed within the components 15 and 16 that are to be joined together, as shown in FIG. 11 (the switches 53 have been omitted from FIG. 11 for clarity).

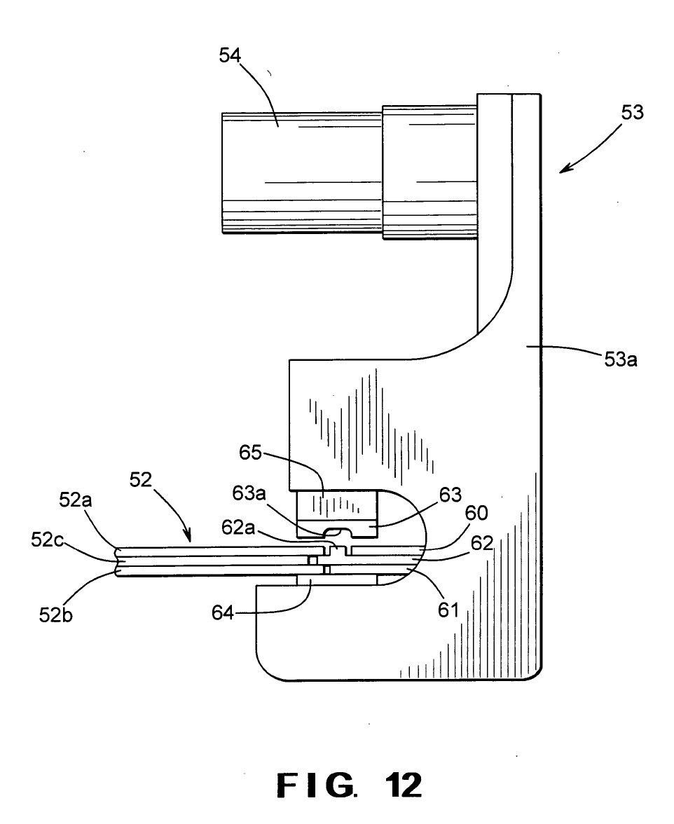

At the same time, the switches 53 are positioned to selectively engage the power distribution bus 52. The structure of one of the switches 53 in this position relative to the power distribution bus 52 is illustrated in FIGS. 12 and 13. As shown therein, the switch 53 includes a housing 53a upon which the inductor 54 is supported. As discussed above, the inductor 54 is conventional in the art and includes an electromagnetic coil (not shown) that is composed of a winding of an electrical conductor having a pair of leads that extend therefrom. In the illustrated embodiment, the leads of the coil are electrically connected to first and second contacts 60 and 61 that are supported on the housing 53a. The first and second contacts 60 and 61 are each formed from an electrically conductive material and are separated from one another by an intermediate spacer 62 that is formed from an electrically insulative material. If desired, a raised rib 62a can be provided on the intermediate spacer 62 for a purpose that will be explained below.

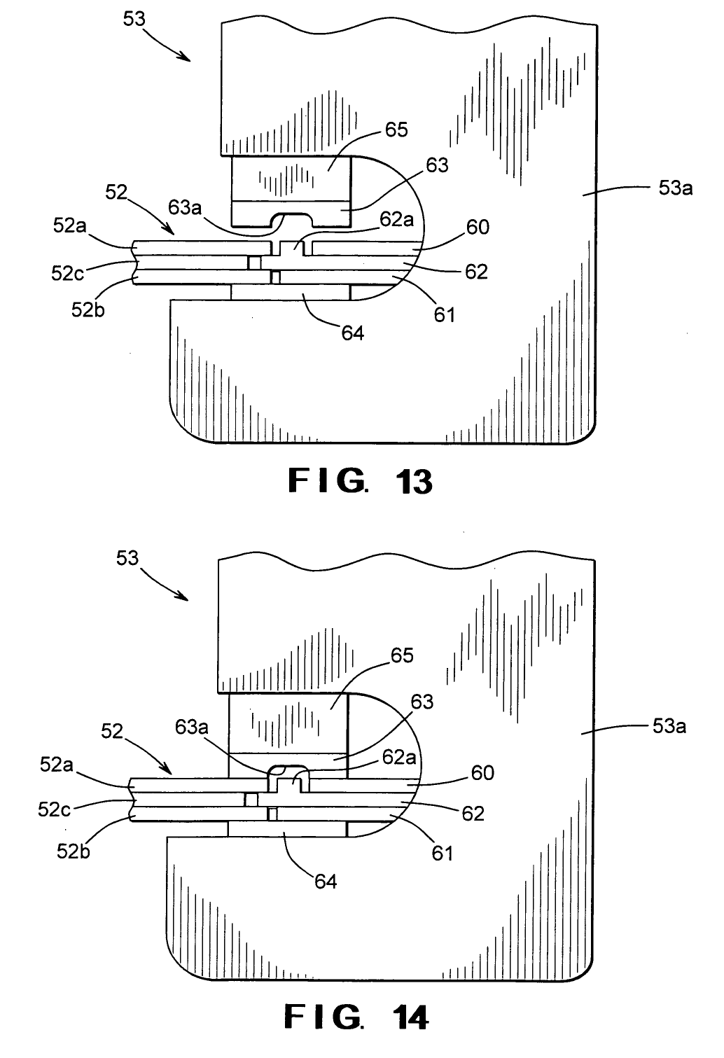

The switch 53 further includes a switching mechanism for selectively causing the first conductive plate 52a of the power distribution bus 52 to be electrically connected to the first contact 60 of the coil of the inductor 54, and the second conductive plate 52b of the power distribution bus 52 to be electrically connected to the second contact 61 of the coil of the inductor 54. In the illustrated embodiment, this switching mechanism includes first and second connectors 63 and 64, each of which is formed from an electrically conductive material. The first connector 63 is supported on a movable ram of a pressing device 65 that is supported on the housing 53a of the switch 53. The pressing device 65 can be embodied as any conventional device for exerting a force to move the first connector 63, such as a conventional hydraulic or pneumatic actuator. The first connector 63 can be formed having a recessed area 63a that is aligned with the raised rib 62a provided on the intermediate spacer 62 for a purpose that will be explained below. The second connector 64 is supported on a fixed supporting portion of the housing 53a of the switch 53. The pressing device 65 is adapted to move the first connector 63 between an opened position (illustrated in FIGS. 12 and 13), wherein the first connector 63 is moved upwardly away from the second connector 64, and a closed position (illustrated in FIG. 14), wherein the first connected 63 is moved downwardly toward the second connector 64.

Initially, the pressing device 65 is activated to move the first connector 63 to the opened position illustrated in FIGS. 12 and 13, wherein the first connector 63 is moved upwardly to a spaced apart position relative to the second connector 64. This allows the switch 53 to be positioned by the actuators such that the edge of the power distribution bus 52 is received between the first and second contacts 63 and 64 of the switch 53, as also shown in FIGS. 12 and 13. Preferably, a portion of the intermediate spacer 62 of the switch 53 is received between the outermost portions of the conductive plates 52a and 52b of the power distribution bus 52, although such is not required. In this initial position, the first conductive plate 52a of the power distribution bus 52 is laterally aligned with the first connector 60 of the switch 53, the insulator plate 52c of the power distribution bus 52 is laterally aligned with the intermediate spacer 62 of the switch 53, and the second conductive plate 52b of the power distribution bus 52 is laterally aligned with the second connector 61 of the switch 53.

Next, the pressing device 65 is activated to move the first connector 63 to the closed position illustrated in FIG. 14, wherein the first connector 63 is moved downwardly toward the second connector 64. Such movement causes the first connector 63 to firmly engage the adjacent ends of the first conductive plate 52a of the power distribution bus 52 and the first connector 60 of the switch 53. At the same time, such movement causes the second connector 64 to firmly engage the adjacent ends of the second conductive plate 52b of the power distribution bus 52 and the second connector 61 of the switch 53. Preferably, the pressing device 65 exerts a substantial amount of force to insure that each of the connectors 60 and 60 firmly and securely engages the associated portions of the power distribution bus 52 and the switch 53. As a result, the inductor 54 is electrically connected to the conductive plates 52a and 52b of the power distribution bus 52. When the power supply 51 is subsequently activated, electrical current flows through the coil of the inductor 54, causing an intense electromagnetic field to be generated thereabout. Consequently, a permanent joint is formed between the portions of the side rail 15 and the end of the cross member 16 as described above.

As is well known, a relatively large amount of electrical energy is required to effect each of the magnetic pulse welding operations described above. In order to minimize the amount of such electrical energy that is required to perform each of these magnetic pulse welding operations, it is desirable to reduce the amount of inductance that is experienced by the apparatus during use. In particular, it is desirable to reduce the amount of inductance that is experienced by the power distribution bus 52 during use. The presence of a significant amount of inductance generates losses and, therefore, increases the amount of electrical energy that is required to perform each of these magnetic pulse welding operations. Generally speaking, the inductance of the power distribution bus 52 can be minimized in several ways. First, the length of the power distribution bus 52 between the power supply 51 to the switches 54 can be minimized. Second, the cross sectional area of the conductive plates 52a and 52b can be maximized. Third, the distance separating the conductive plates 52a and 52b can be minimized.

In the illustrated power distribution bus 52, it can be seen that the length of the power distribution bus 52 between the power supply 51 to each of the switches 54 may be different, depending upon the location of each of such switches 54. As a result, the magnitude of the inductance of the power distribution bus 52 may vary for each of the switches 54. To compensate for this, it may be desirable to adjust the amount of electrical energy that is provided by the power supply 51 to each of the switches 54 in accordance with the magnitude of the inductance experienced by each of such switches 54. In other words, the amount of electrical energy that is provided by the power supply 51 to each of the switches 54 will depend upon the location of the switch 54 that is being operated.

Alternatively, since the amount of electrical energy is required to effect each of the magnetic pulse welding operations may not be uniform, depending upon a variety of factors (including, for example, the geometry of the joint that is being formed and the materials that are being used to form the components 15 and 16), it may be desirable to maintain the amount of electrical energy that is provided by the power supply 51 at a constant level, and locate each of the switches 54 to achieve the amount of electrical energy that is required to effect the magnetic pulse welding operation at each location.

In each of the illustrated embodiments, a mechanical mechanism has been utilized for the power distribution device or mechanism. However, as described above, any desired mechanical and electrical structures can be utilized to selectively connect the power supplies to the inductors. For example, referring back to FIG. 1, the power distribution system 12 can be embodied as a solid state or other electronic switching system for selectively connecting the power supply 11 to each of the inductors 13. Such solid state or other electronic switching systems are known in the art and can be adapted for use with the specific application for the magnetic pulse forming/welding apparatus 10.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. An apparatus for performing a plurality of magnetic pulse forming or welding operations comprising:
a power supply;
a plurality of inductors; and
a power distribution system for selectively connecting said power supply to each of said plurality of inductors so as to perform a plurality of magnetic pulse forming or welding operations.

2. The apparatus defined in claim 1 wherein said power distribution system includes a power distribution device having a connection arm that can be connected to each of said plurality of inductors.

3. The apparatus defined in claim 2 wherein said power distribution device is movable relative to said plurality of inductors such that said connection arm that can be connected to each of said plurality of inductors.

4. The apparatus defined in claim 1 wherein said power distribution system includes a power distribution device having a connection cable that can be connected to each of said plurality of inductors.

5. The apparatus defined in claim 1 wherein said power distribution system includes a power distribution device having a plurality of connection cables that can be respectively connected to each of said plurality of inductors.

6. The apparatus defined in claim 1 wherein said power distribution system includes a solid state switching system for selectively connecting said power supply to each of said plurality of inductors.

7. The apparatus defined in claim 1 wherein said power distribution system includes an electronic switching system for selectively connecting said power supply to each of said plurality of inductors.

8. The apparatus defined in claim 1 wherein said power distribution system includes a power distribution bus.

9. The apparatus defined in claim 8 wherein said power distribution bus includes first and second electrical conductors that are separated by an electrical insulator.

10. The apparatus defined in claim 9 wherein said first and second electrical conductors include first and second flat, planar conductor plates, and wherein said electrical insulator includes a flat, planar insulator plate disposed between said first and second conductor plates.

11. The apparatus defined in claim 8 wherein said power distribution system further includes a plurality of switches respectively associated with said plurality of inductors for selectively connecting each of said inductors to said power distribution bus.

12. The apparatus defined in claim 11 wherein each of said plurality of switches is supported for movement relative to said power distribution bus.

13. The apparatus defined in claim 11 wherein each of said plurality of switches includes first and second contacts that are connected to said associated inductor and are adapted to be selectively connected to said power distribution bus.

14. The apparatus defined in claim 13 further including means for selectively connecting to said first and second contacts of said switch to said power distribution bus.

15. The apparatus defined in claim 1 wherein said means for selectively connecting includes a pressing device having a movable ram.
